(19) United States
(12) Patent Application Publication
(10) Pub. No.: US 2008/0276902 A1
(43) Pub. Date: Nov. 13, 2008

(54) Rotary Piston Machine Comprising Two Piston Mounts Arranged on an Axle

(75) Inventors: Reinhard Manthry, Berlin (DE); Reiner Schwabisch, Atllandsberg (DE)

Correspondence Address: NORRIS, MCLAUGHLIN & MARCUS, P.A., 875 THIRD AVE, 18TH FLOOR, NEW YORK, NY, 10022, US

(73) Assignees: Reinhard Manthey, Berlin (DE); Reiner Schabisch, Altlandsberg (DE)

(21) Appl. No.: 12/090,220

(22) PCT Filed: Dec. 14, 2006
(86) PCT No.: PCT/EP06/12029

§ 371 Date: Jun. 27, 2008

(30) Foreign Application Priority Data
Dec. 20, 2005 (DE) 10 2005 061 286.5

(51) Int. Cl. F02B 55/02

(52) U.S. Cl. 123/238

(57) ABSTRACT

The object of the invention of developing a rotary piston machine, which is to be embodied as a prime mover or as a work machine consisting of two piston mounts rotatably mounted on an axle and being capable of performing a relative movement, wherein they are connected to a straight-line thrust crank mechanism, which serves to generate a relative movement, which causes a conversion of a uniform movement into an non-uniform straight-line movement of the piston mount, was solved in that a center axle of each piston liner stands at right angles on a diameter of a piston mount and in that each piston mount comprising elliptical gearwheels, which are turned relative to one another by 90° and the gearwheels, as mating gears being turned relative thereto by 90°, are fixedly connected to an output, wherein they are rotatably mounted on the axle in the point of intersection of the smallest and of the greatest diameter, on the one hand, and are connected to the output shaft on the other hand, and the working pistons in the piston liners of the one piston mount are connected to the other piston mount via hinged levers and the working pistons in the piston liners of the other piston mount are connected to the first piston mount via hinged levers.

The invention relates to a rotary piston machine, which can be used as a prime mover as well as a work machine comprising two piston mounts centrically mounted on an axle and capable of performing a relative movement to one another, which are provided with at least two piston liners, which are arranged so as to be offset by 180° on a defined orbit comprising a constant diameter and with working pistons provided therein, wherein said piston mounts are connected to one another via each of said working pistons, which are provided with a hinged lever and wherein the piston mounts are connected on the one hand to a drive/output shaft, depending on the embodiment as prime mover or work machine and, on the other hand, to one of the piston mounts in each case, in each case by means of a gear mechanism, which encompasses in each case two gearwheels comprising an elliptical embodiment, which, in the point of intersection of its smallest and with its greatest diameter comprising an axle distance, the sum of which from the smallest and greatest diameter is always constant.

According to DE 36 21 593 A1, a rotary piston machine is known, which is characterized as a stator-rotor group for a rotary piston-like machine comprising compression and expansion chambers. The machine described in this document has two rotationally symmetrical piston mounts mounted on an axle, which are brought into rotation by means of ring segment pistons in cylindrical ring channels, wherein a partial movement directed forwards and backwards is superposed to said rotating movement and the pistons are arranged on piston mounts, which are movable relative to one another and which can be embodied so as to be like a solid disk or a ring disk. Said superposed partial movement is created by means of a crank mechanism in a drive embodied as an epicyclic gear mechanism and a planetary gear mechanism, respectively, for transferring a rotary movement from a uniform into a non-uniform movement for the rotary piston machine. For this purpose, the piston mounts are coupled to the planetary gear mechanism, wherein, in response to a rotation of the planetary gear mechanism in the course of a running of the epicyclic gear mechanisms on a core gear mechanism, a pair of crank block disks are rotated on the periphery at a non-uniform speed in response to a rotation of eccentric disks due to the displacement caused therewith so that the piston mounts are rotated faster than the crank block disks in the one approximately half rotating region and are rotated slower in the other one. In response to this conversion of the rotational movement from a uniform movement into a non-uniform movement, the piston mounts and the ring segment pistons connected thereto in the concentric cylindrical ring channel are moved forward on the circular orbit so as to swing back and forth. In the event of a non-uniform drive of the ring segment pistons, as is the case with piston combustion engines, said back and forth rotation is transferred to a shaft.

This technical solution has the disadvantage that the design of a planetary gear mechanism, which is used for creating a relative movement of the piston mounts, is very extensive. Through this, the mass/performance ratio is very disadvantageous. Furthermore, the embodiment of a ring segment piston operating in a ring channel is highly susceptible to interference and cannot be realized in practice.

According to DE 38 04 411 A1, a center axle rotary piston-like rotary piston machine comprising two rotors (piston mounts) mounted at the center axle, at which provision is made for annularly bent pistons, which dip into annularly bent cylinders and comprising a circular cross section are known, wherein said rotors (piston mounts), for attaining a periodically changing ratio of the angular speed thereof are connected to a straight-line thrust crank mechanism, which is arranged so as to be offset by 90° and connected to one another and consisting of a double eccentric lever drive, which in this document is characterized with the technically incorrect term oval gear mechanism.

Each of said eccentric lever drives of the straight-line thrust crank mechanisms for said rotary piston machine consists of two elliptical oval gear mechanisms. All of the controlling oval gear mechanisms are fixedly connected to a common axle in the focal points, that is, not in the centers thereof, the point of intersection of the small and large diameter of their ellipses and they are arranged so as to be turned relative to one another by a defined angle. The two other oval gear mechanisms of each eccentric lever drive are fixedly connected in each case with a piston mount, which is characterized as a rotor; they mesh with the two first oval gear mechanisms.

The oval gear mechanisms connected to the two piston mounts are also eccentrically mounted to said piston mounts in the focal points of their ellipses. The dimensioning of the eccentric lever drive provided with oval gear mechanisms was based on the geometric features of the ellipses. Due to the fact that the ellipsis is the geometric location of all points, for which the sum of the distances from the two focal points is constant and said sum corresponds to the length of the large axis of the ellipsis, the distance between the common “axle” (however, this refers to a shaft herein) of the fixedly connected oval gear mechanisms and of the center axle of the piston mounts has been chosen according to the length of the large axis of the ellipsis.

If the shaft, which is characterized as “axle” is rotated with the two oval gear mechanisms, which are fixedly connected thereto, the two piston mounts (rotors)—driven via the eccentric lever drives—constantly move in the same direction, but at different angular speeds, so that they rotate with a constantly alternating acceleration-delay rhythm, that is, they catch up with one another, thus creating the piston travel.

The compression and expansion spaces are created by different relative speeds between the piston in the cylinder of the one piston mount and the other piston mount, which are generated by the eccentric lever drives. The machine includes four, six or more cylinders and the same number of pistons. A rotor (piston mount) can either carry all of the cylinders and the other rotor can carry all of the pistons or each rotor (piston mount) carries the same amount of cylinders and pistons, namely two, three or more cylinders and pistons. In a rotor comprising two n(n=1, 2 . . . ) cylinders and pistons, the cylinders as well as the pistons are offset by 180°:n.

A rotary piston machine configured according to this teaching encompasses the flaw that it is not able to work because it cannot be realized according to the information from the invention description.

It is the goal of the invention to secure the functionality of a rotary piston machine as well as to guarantee a production with a justifiable effort.

The invention is based on the object of developing a rotary piston machine comprising a high degree of efficiency, which can be selectively embodied as a prime mover or as a work machine.

According to the invention, this object is solved by means of the technical means disclosed in claim 1. The features disclosed in the dependent claims refer to an embodiment of the means of the independent claim.

The invention is to be defined below in more detail by means of an exemplary embodiment. In the corresponding drawings:

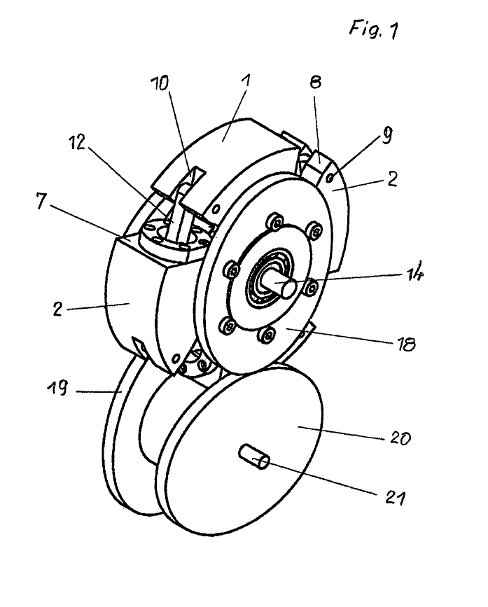

FIG. 1 shows a rotary piston machine in a perspective illustration without a machine housing,

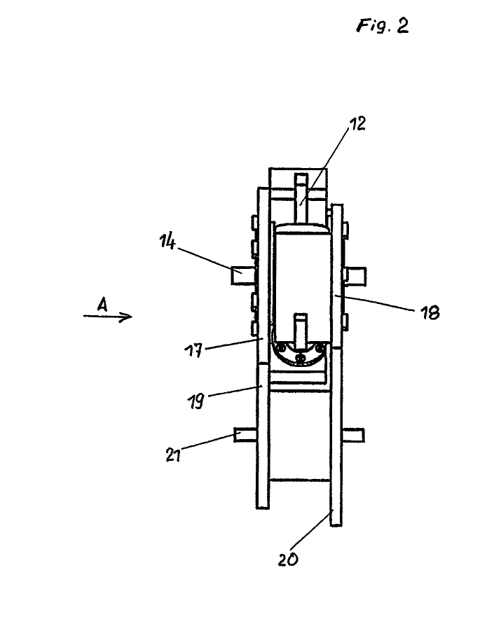

FIG. 2 shows a top view of the rotary piston machine embodied according to the invention,

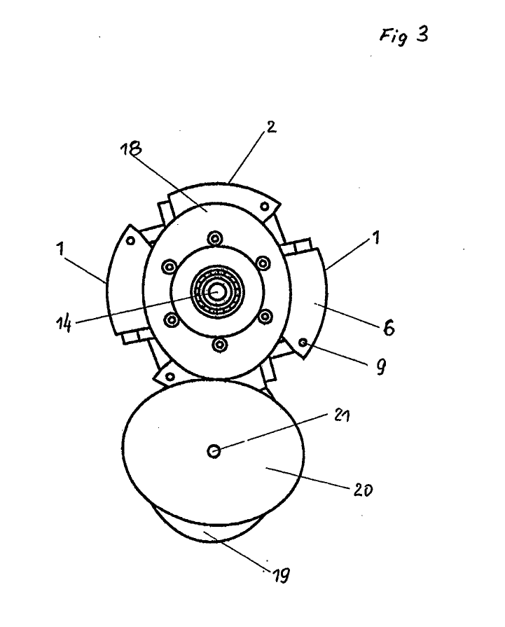

FIG. 3 shows a side view from direction A according to FIG. 2,

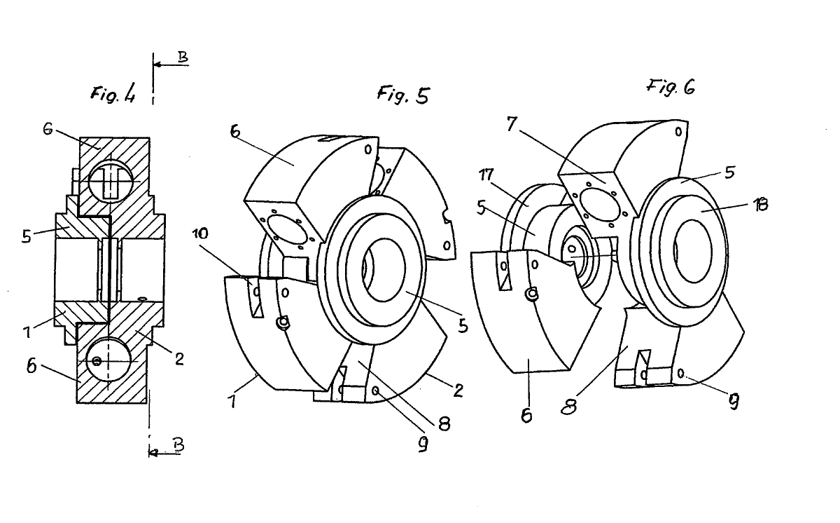

FIG. 4 shows an arrangement of the piston mounts in a radial sectional view,

FIG. 5 shows a perspective illustration of the arrangement of the piston mounts relative to one another according to FIG. 4,

FIG. 6 shows a perspective illustration of the arrangement of the piston mounts relative to one another prior to the assembly,

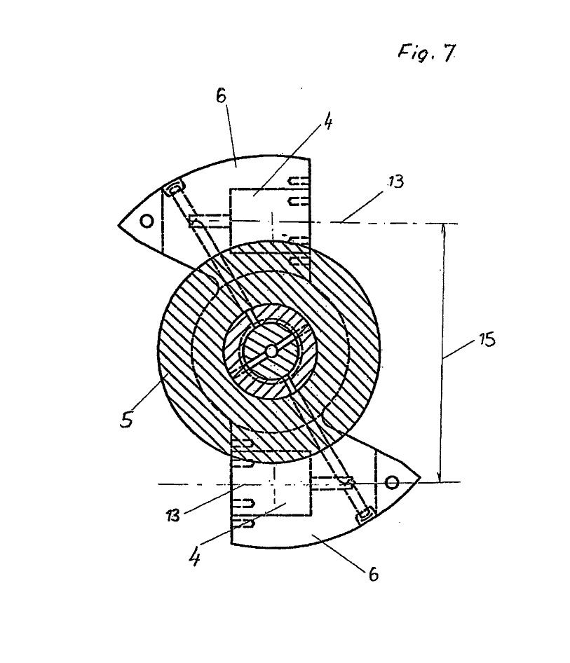

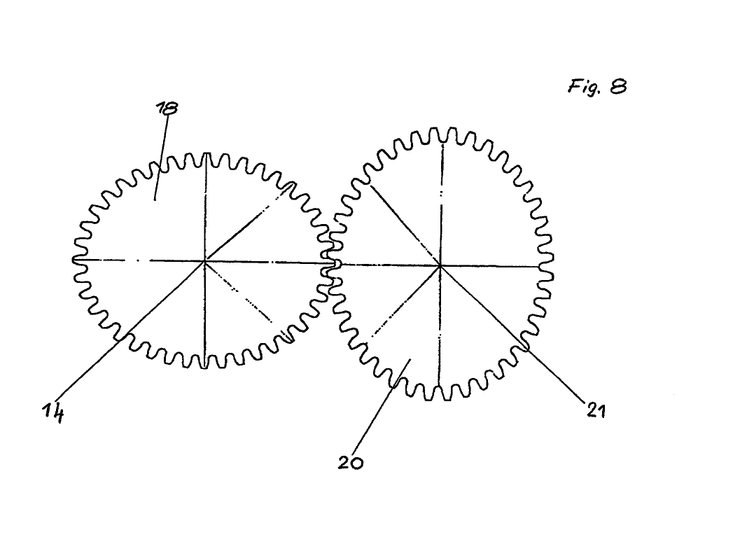

FIG. 7 shows a piston mount in sectional view B-B according to FIG. 4,

FIG. 8 shows two gearwheels engaged with one another comprising an elliptical design,

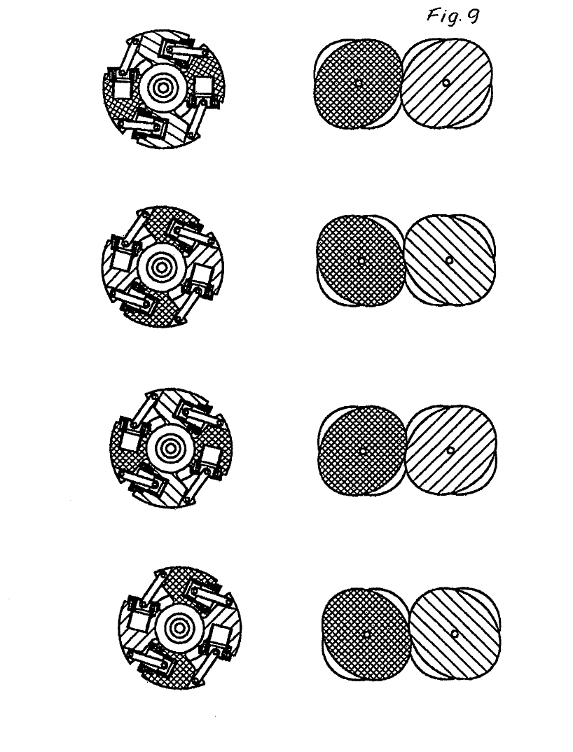

FIG. 9 shows a schematic illustration of the piston mounts of the rotary piston machine in four positions, each of which are rotated by 90° comprising the corresponding position of the elliptical gearwheels of the gear mechanism provided with oval gearwheels for forcing a relative movement of the piston mounts.

The rotary piston machine comprising an oval gearwheel, which controls the required relative movement between two piston mounts 1; 2 embodied according to the invention is located in a non-illustrated machine housing. The rotary piston machine consists of two separate rotationally symmetrical piston mounts 1; 2 comprising in each case two piston liners 3; 4, which are arranged relative to one another so as to be offset by a 180° angle. Each piston mount 1; 2 consist of two parts forming a structural unit, a receiving part 5 and two head parts 6, which are arranged so as to be offset relative to one another at an angle of 180° and which are embodied like a segment of a circle, wherein head parts 6, which are arranged so as to be offset by a 180° angle and which are embodied so as to be discoid, are attached to the discoid receiving part 5 with a slight axial extension in radial direction with an axial extension, which is determined by the piston liners 3; 4. The head part 6 is defined in radial direction by two end faces 7; 8, which are located opposite to one another, which extend an axial direction and which intersect one another under an angle of expansion of approx. 45°. A piston liner 3; 4 is in each case arranged in one of the end faces 7 of each head part 6. The other end face 8 encompasses a slit-shaped recess 10, which is provided with a cross-hole 9 for receiving a hinged lever 12, which is unilaterally connected to a working piston 11 and which receives tractive and compressive forces. Each center axis 13 of the piston liners 3; 4 intersects a diameter of the piston mount 1; 2 at right angles. The piston liners 3; 4 are thus tangentially arranged in the piston mounts 1; 2.

The piston mounts 1; 2 are arranged on a common axle 14 so as to be rotatable independent on one another and so as to be mirror-symmetrical relative to one another comprising head parts 6, which are offset at 180°, wherein the center axles 13 of all of the piston liners 3; 4 are located on a pitch circle comprising a constant diameter 15. This arrangement is based on the fact that the receiving part 5 of each piston mount 1; 2 encompasses an axial extension, which is smaller as compared to the head part 6, wherein the head part 6 is unilaterally flush with the receiving part 5 and is embodied on the opposite side to this flush closure so as to project out.

On the flush closure surface 16 of head part 6 and receiving part 5, each piston mount 1; 2 comprising in each case a gearwheel 17; 18, which encompasses an elliptical design, is connected to the rotary piston machine in a non-positive manner, wherein the gearwheel 17 connected to the piston mount 1 is arranged so as to be offset at an angle of 90° opposite to the gearwheel 18 connected to the piston mount 2. The embodiment of both of the gearwheels 17; 18 is identical.

The gearwheels 17; 18 of the rotary piston machine, which encompass an elliptical shape, are engaged with gearwheels 19; 20, which are connected in a non-positive manner to an output shaft 21 at their points of intersection of the respectively greater diameter to the smaller diameter, wherein the gearwheels 19; 20 connected to the output shaft 21 are arranged on the output shaft 21 so as to be rotated by 90° with respect to one another. The gearwheels 19; 20 connected to the output shaft 21 encompass an elliptical shape and the outer shape and the dimensions thereof are identical to the gearwheels 17; 18 of the rotary piston machine.

Two identical gearwheels comprising an elliptical shape, which are arranged so as to be turned relative to one another by 90° and which are engaged with one another are illustrated in FIG. 8 with a ratio of the small diameter to the large diameter of 1:1.2. The tooth flanks of the gearwheels comprising an elliptical shape encompass a tooth flank correction, which is a function of the gearwheel diameter, which is a function of the rotation angle and which thus constantly and steadily changes via the gearwheel periphery.

The rotary piston machine, which can be used as a prime mover or as a work machine, is functional only with the proposed oval gear mechanism of the afore-mentioned embodiment.

### LIST OF REFERENCE NUMERALS

1 piston mount

2 piston mount

3 piston liner

4 piston liner

5 receiving part

6 head part

7 end face

8 end face

9 cross-hole

10 recess

11 working piston

12 hinged lever

13 center axle

14 axle

15 diameter

16 closure surface

17 gearwheel

18 gearwheel

19 gearwheel

20 gearwheel

21 output shaft

1. A rotary piston machine consisting of two piston mounts centrically mounted on an axle independent on one another so as to be rotatable and so as to be capable of performing a relative movement to one another, which are connected to a straight-line thrust crank mechanism, which serves to generate a relative movement of the piston mounts and causes a conversion of a uniform rotary movement into an non-uniform straight-line movement of the piston mount in each case, wherein they are connected to a drive/output shaft at the drive/output side to a double drive so as to be offset at an angle and each piston mount encompasses at least two piston liners, which are arranged so as to be offset by 180° on a defined orbit comprising a constant diameter with a working piston provided therein in each case, wherein the piston mounts are connected to one another via the working pistons, characterized in that a center axle (13) of each piston liner (3; 4) stands in each case at right angles on a diameter (15) of the respective piston mount (1; 2) and each piston mount (1; 2) is connected to gearwheels (17; 18), which are turned relative to one another by 90° and which encompass the shape of an ellipsis, wherein the gearwheels (17; 18) are connected to the respective piston mounts (1; 2) turned relative to one another by 90° and the gearwheels (19; 20), which are used as mating gears being turned relative to one another by 90° are fixedly connected to an output shaft (21) and are thus components of a oval gear mechanism, wherein the elliptical gearwheels (17; 18; 19; 20) are rotatably mounted on the axle (14) in the point of intersection of the smallest diameter and of the greatest diameter, on the one hand, and on the output shaft (21) on the other hand, and the working pistons (11), which are arranged in the piston liners (3) of the one piston mount (1) are connected to the other piston mount (2) via hinged levers (12) and the working pistons (11), which are arranged in the piston liners (4) of the other piston mount (2) are connected to the first piston mount (1) via hinged levers (12).

2. The rotary piston machine according to claim 1, wherein—piston liners (3; 4) are embodied so as to be straight-lined.

3. The rotary piston machine according to claim 1, wherein the end faces (7; 8) defining the head parts (6) draw an angle of approx. 45° and in that there is a movement space between the head parts (6) of the piston mount (1) and the head parts (6) of the piston mounts (2), which allows for a relative movement between the piston mounts (1; 2).

4. The rotary piston machine according to claim 1, wherein each piston mount (1; 2) consists of a discoidal receiving part (5) and a two-part head part (6.1; 6.2), wherein a piston liner (3; 4) is in each case provided in each head part (6.1; 6.2).

5. The rotary piston machine according to claim 1, wherein each of the working pistons (11) arranged in the piston liners (3; 4) is connected to a hinged lever (12), which transfers tractive and compressive forces.

6. The rotary piston machine according to claim 1, wherein the piston mounts (1; 2) encompass at least two piston liners (3; 4) or a multiple of two piston liners (3; 4).

7. The rotary piston machine according to claim 1, wherein it can be used as a prime mover as well as a work machine.

8. The rotary piston machine according to claim 1, wherein, depending on the embodiment, the operating shaft (21) is provided as an output shaft or as a drive shaft.
